(19) United States
(12) Patent Application Publication
(10) Pub. No.: US 2012/0098785 A1
(43) Pub. Date: Apr. 26, 2012

(54) Garment with Touch-Sensitive Features

(76) Inventors: Josef Tatelbaum, Quincy, MA (US); Dennis Baacke, Irma, WI (US)

(21) Appl. No.: 13/204,378

(22) Filed: Aug. 5, 2011

Related U.S. Application Data
(60) Provisional application No. 61/426,890, filed on Dec. 23, 2010.
(60) Provisional application No. 61/420,063, filed on Dec. 6, 2010.
(60) Provisional application No. 61/420,061, filed on Dec. 6, 2010.
(60) Provisional application No. 61/406,310, filed on Oct. 25, 2010.

(51) Int. Cl. A41D 1/00; G06F 3/045; B08B 1/00

(52) U.S. Cl. 345/174; 2/69; 134/6

(57) ABSTRACT

A garment including a shell adapted to receive a portion of a finger of a wearer therein, the shell having an interior surface, an exterior surface and an aperture for receiving the finger of the wearer and at least one conductive member disposed on the exterior surface of the shell, the at least one conductive member capable of conducting a signal recognizable by a touch-sensitive device. The garment can also include at least one cleaning material piece thereon to be used to clean a control surface of the device.

### CROSS-REFERENCE TO RELATED APPLICATIONS

This application claims priority from U.S. Provisional Application Ser. No. 61/426,890, filed Dec. 23, 2010, U.S. Provisional Application Ser. No. 61/420,063, filed on Dec. 6, 2010, U.S. Provisional Application Ser. No. 61/420,061, filed on Dec. 6, 2010, and U.S. Provisional Application Ser. No. 61/406,310, filed on Oct. 25, 2010, the entirety of which are each expressly incorporated herein by reference.

### FIELD OF THE INVENTION

The present invention relates generally to a garment, and more specifically to a garment having touch-sensitive features.

### BACKGROUND OF THE INVENTION

There are many types of electronic devices that are used for various reasons, including but not limited to, communications, entertainment, work, and maintaining information such as contacts and appointments. Many electronic devices are continuously decreasing in size while increasing in functionality. Several types of electronic devices are portable, such as phones, pagers, communicators, electronic organizers, personal digital assistants, tablet computers and digital audio and/or video playing devices such as iPods® or MP3 players.

The particular controls and methods of input for different electronic devices can vary. Some devices may include mechanical buttons or switches that can be activated by a user contacting the button or switch. Often, conventional hand coverings do not enable a user to accurately select and press a small mechanical button or switch.

Other electronic devices utilize a touch-sensitive technology for the interaction between the user and the device. One example of a touch sensitive technology is a touch screen which is an interactive screen that can be contacted by a user. Another example of a touch-sensitive technology is a track pad. The touch-sensitive technologies or applications sense and track a user's touch and its subsequent movement.

Some applications are resistive-type systems that include a resistive layer of material and a conductive layer of material that are disposed proximate to each other and separated by a narrow space of air. When a user touches a resistive-type screen or pad, the two layers contact each other in that exact spot, thereby changing the electric field and the particular spot can be identified. Thus, a resistive-type system registers a touch or input as long as the two layers make contact. The contact can be made using any type of object.

Other applications are capacitive-type systems that include a conductive layer of material that stores an electrical charge. When a user touches a capacitive-type screen or pad, a portion of the charge is transferred between the user and the screen or pad. As a result, the charge on the capacitive layer changes. Once this change occurs, the particular location of the change can be determined by a controller. A capacitive system needs a conductive input to register a touch or input. Such a conductive input can be made using a portion of a user's body, such as a finger.

In an electronic device with a capacitive-type touch-sensing interface, a controller supplies electrical current to metal channels or conductors that form a grid and conduct electricity. When another conductor, such as a user's finger, is moved close to the grid, current wants to flow to the finger to complete a circuit. Typically, the electronic device includes a non-conductive item, such as a non-conductive piece of plastic, in the way. Thus, a charge builds up at a point on the grid that is the closest to the finger. The build up of electrical charge between two conductors is called capacitance. The controller of the electronic device measures any changes in capacitance and a signal is generated and sent to the microprocessor of the electronic device.

As electronic devices become smaller, the available space for input or control structures on the electronic devices decreases as well. Resistive-type and capacitive-type touch-sensing technologies are utilized on electronic devices. These touch-sensing technologies use capacitive and resistive buttons which can replace the small mechanical button and switch input devices. As mentioned above, capacitive touch-sensing requires a conductive input to register a touch by a user. While a conductive input can be accomplished through the touch of a user, such a conductive input is difficult when a user is wearing a garment covering the portion of the user's body intended to provide the conductive input, such as a hand covering. Garments, such as hand coverings including gloves and mittens are worn for protection from cold weather or other environmental conditions. There is a decrease in tactile sensitivity when a user is wearing a conventional garment. In addition, conventional garments do not allow a user to provide a necessary conductive input to an electronic device. Accordingly, to operate and utilize many electronic devices, a user must remove the garment in order to effectively interact with the devices.

Certain garments have been developed that enable the wearer to interact with a conductive input device without removing the garment by replacing portions of the material forming the garment with section of a conductive material. However, while this enables the individual wearing the garment to interact with the device, the incorporation of the item used to interact with the device into the garment often requires significant modification to the form of the garment.

Additionally, as the garment including the item used to interact with the touch-sensitive device is often worn in outside environments, the garment itself may have some materials thereon, such as dirt, dust, water, etc., that can obscure the interface when contacting the device, resulting in detrimental effects regarding the proper interaction of the garment with the interface of the touch-sensitive device.

Thus, it is desirable to develop a garment that enables the wearer to provide conductive input to an electronic device, but that also has a relatively simple construction. Also, it is desirable that the garment have the ability to remove any obscuring materials from the interface of the touch-sensitive device to maintain or improve the interaction between the garment and the device.

### SUMMARY OF THE INVENTION

Briefly described, one aspect of the present disclosure provides a garment, such as a hand or finger covering including one or more receptacles for fingers and a thumb. The garment also includes at least one conductive member coupled thereto. In one embodiment, the conductive member is formed from one or more materials that facilitate a conductive input to an electronic device and extend along the exterior of the garment such that the conductive member can be positioned in direct contact with an electronic device. In one embodiment, the conductive member is coupled at one end within the interior of the garment in order to be positioned in contact with the wearer. The conductive member is formed from one or more materials that facilitate a conductive input to an electronic device and extends from the interior of the garment through an aperture of the garment that is adapted to receive a portion of the wearer's body therethrough and is spaced from the position of the body portion in the garment. From the aperture, the conductive member extends along the exterior of the garment such that it can be positioned in direct contact with an electronic device. Thus, when in contact with the device, the conductive input from the wearer can be transmitted from the inside of the garment along the conductive member to the electronic device. Alternatively, the aperture can be formed in the garment to provide a more direct path for the conductive member.

According to another object of the present invention, the amount of the conductive material positioned on the exterior of the garment can sufficient to create a detectable input on the device without any direct contact of the conductive member with the body of the wearer, enabling the wearer to interact with the device solely via the conductive member. Thus, instead of having to remove the garment to directly contact the device, or to have a conductive member that penetrates the garment, the conductive member, based on its mass and/or size, is able to provide the necessary input to the device without any direct contact with the body of the wearer.

According to another aspect of the present disclosure, the garment has a projection extending from one or more portions of the garment. The projection is operably connected to the conductive member in order to enable signals generated by the component to be transmitted through the conductive member to the projection. The form of the projection allows the signal to be directed precisely onto the device to enable the wearer to closely and accurately control the operation of the device.

According to a further aspect of the present disclosure, the garment can be formed for use on one or more fingers of the wearer, without any portion of the garment disposed over the back or palm of the hand of the wearer. The garment can be formed as a finger sleeve, having the conductive member disposed on the exterior of the sleeve for interaction with an electronic device.

According to still another aspect of the present disclosure, the garment can be formed with a material located on one or more portions of the garment that is able to clean and/or remove dirt and other particulate matter from the interactive surface of the electronic device to facilitate the control of the device utilizing the conductive member positioned on the garment.

Numerous other aspects, features, and advantages of the present invention will be made apparent from the following detailed description together with the drawings figures.

### BRIEF DESCRIPTION OF THE DRAWINGS

The drawings illustrate the best mode currently contemplated of practicing the present disclosure.

In the drawings:

FIG. 1 is a side plan view of a one embodiment of a garment constructed according to the present disclosure;

FIG. 2 is a bottom plan view of the garment of FIG. 1;

FIG. 3 is a top plan view of the garment of FIG. 1;

FIG. 4 is a cross-sectional view along line 4-4 of FIG. 2;

FIG. 5 is a cross-sectional view similar to FIG. 4 of a second embodiment of the garment of FIG. 4; and

FIG. 6 is a cross-sectional view similar to FIG. 4 of a third embodiment of the garment of FIG. 4.

### DETAILED DESCRIPTION OF THE INVENTION

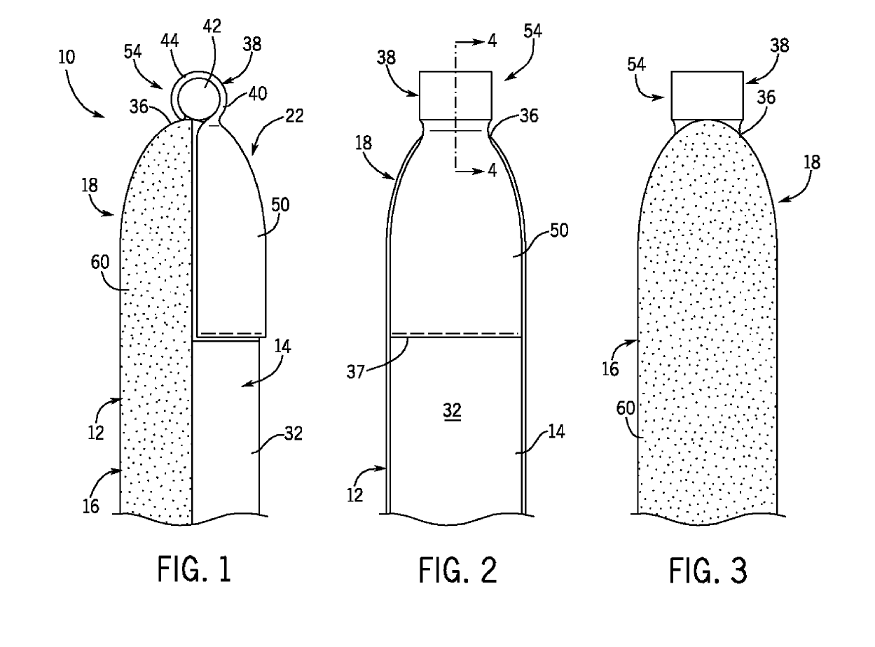

Referring now in detail to the drawing figures, wherein like reference numerals represent like parts throughout the several views, one embodiment of a garment constructed according to the present disclosure is illustrated generally at 10 in FIG. 1. The garment 10, which in this embodiment is formed as a finger stall 18 but can also be any type of garment worn by an individual, includes a shell 12 formed of a suitable waterproof or weather proof material. The shell 12 is shaped to conform to the portion of the body of the wearer on which the garment 10 is to be worn. In the illustrated embodiment, the shell 12 is formed to conform to the shape of a finger 28 with a palm portion 14, and a back portion 16, though in other embodiments the garment 10 can be formed to accommodate more than one finger and/or the hand of an individual, or can be formed to be releasably attachable to another garment. In one embodiment, the shell 12 is formed as a single member, without any breaks in the shell 12 such that the shell 12 provides continuous waterproof and/or weatherproof protection over the entire hand of the wearer, though a shell 12 formed of multiple components joined to one another to form the unitary or single member is also contemplated. Further, the sleeve 18 can be formed from any suitable natural or synthetic material, but in one embodiment is formed of a flexible material that is able to conform to the shape of a finger 28 of the wearer as the finger 28 moves. The sleeve 18 also includes a cuff 39 that is positioned around an opening 41 defined by the sleeve 18 to receive the finger 28 of the wearer can additionally be formed with an elastic member (not shown) therein that either partially or totally extends around the cuff 39 and operates to expand and frictionally hold the sleeve 18 in position on the finger 28.

Referring now to FIGS. 1-4, the garment 10 additionally includes a conductive member 22. The conductive member 22 is formed of a flexible and electrically conductive material such that electrical signals can pass along the conductive member 22. The conductive member 22 is attached to the exterior surface 32 of the shell 12 and includes a first conductive portion 50 and a second conductive portion 52. The first portion 50 and second portion 52 are formed of a suitable conductive material, such as a silver plated or copper/polyester taffeta strip material that is 0.08 mm in thickness with a mass of 80 g/m². In one embodiment, the first portion 50 is approximately 1″ in length and 0.5″ in width, and extends along an exterior surface of the shell 12 from a tip 36 of the finger stall 18 to an aperture 37 formed in the shell 12. The second portion 52 is approximately 1″ in length and 0.5″ in width, and is connected to the first portion 50 through the aperture 37, from which the second portion 52 extends along the interior surface 26 of the shell 12, optionally to the tip 36.

At the tip 36, the first portion 50 is optionally joined to a contact 54, that in one embodiment is formed approximately 0.75″ in length and 2″ in width strip of a suitable conductive material, such as a silver plated polyester/Lycra® fabric that is 0.50 mm in thickness with a mass of 130 g/m², and is folded to form the contact 54. The first portion 50 is joined to the contact 54 just below the tip 36 of the finger stall 18.

For the contact 54, the contacts 54 are positioned on the exterior surface 32 of the shell 12 at a location where the contacts 54 can interact with an input or control element (not shown) of an electronic device (not shown), including, but not limited to, phones, pagers, communicators, electronic organizers, personal digital assistants, tablet computers, and digital audio and/or video playing devices such as iPods® and MP3 players. In the embodiment shown in FIGS. 1-4, the second portion 52 of the conductive member 22 is positioned in contact with the finger 28 of the wearer and transmits the electric signal along the second portion 52, through the aperture 37 to the first portion 50, and to the contact 54 which is positioned in engagement with a touch-sensitive device than can sense the signal.

In order to engage and provide input to the device, the wearer manipulates the finger stall 18 on which the contact 54 is located to place one of the contacts 54 in contact with the control element of the device. Where the control element of electronic device is or includes a capacitive-type touch-sensing interface, the first portion 50 and second portion 52, with the contacts 54 in contact with the capacitive-type touch-sensing interface generates a conductive signal that is transmitted to the contacts 54 to operate the interface.

In an alternative embodiment shown in FIG. 5, the conductive member 22 can be positioned to wrap around the cuff 39 formed on the shell 12 that defines the opening 41 through which the finger is to be inserted into the shell 12, thereby eliminating the aperture 37 that could compromise the integrity of the waterproof and/or weatherproof properties, etc., of the garment 10.

In still another embodiment shown in FIG. 6, the conductive member 22 can be formed of only the first portion 50 and optionally the contact 54, where the total conductive mass of the first portion 50, optionally along with the mass of the contact 54, is sufficient to generate a signal when the conductive member 22 is in contact with a touch-sensitive device to that is recognizable by and can operate the device without having any direct contact of the first portion 50 with the body of the wearer. In this manner the wearer can interact with the device using the garment 10 without removing the garment 10, and without the garment 10 being formed with any apertures, holes or other points of entry into the garment 10 that could compromise the integrity of the waterproof and/or weatherproof properties, etc., of the garment 10.

In addition to the flexible conductive fabrics, the conductive member 22 can be formed as any suitable conductive device or material having sufficient mass to conduct, or independently generate in the embodiment of FIG. 6, an electric signal that is detectable by a touch-sensitive device to operate the device, such as a conductive ink or adhesive positioned on the interior surface 26 and exterior surface 32 of the shell 12, such as by printing the ink or adhesive thereon, or multiple conductive members 22 can be disposed on the various portions of the shell 12 to form separate or connected points of contact on the exterior surface 32 of the shell 12.

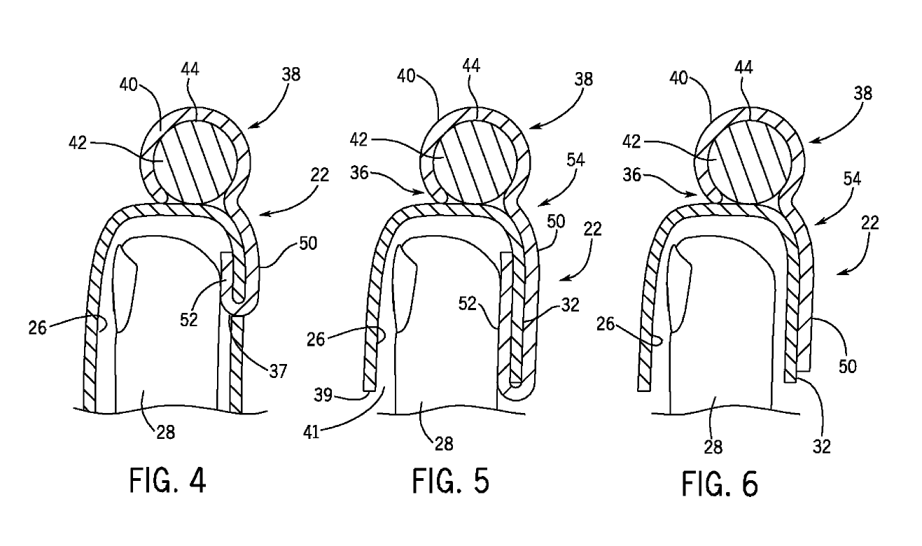

Looking now at FIGS. 4-6, in one embodiment the optional contact 54 includes a projection 38 disposed on the tip 36 of the stall 18. The projection 38 includes an outer portion 40 and an inner portion 42. The outer portion 40 is operably connected to the conductive member 22 at the tip 36 of the stall 18, such that signals travelling along the member 22 can be conducted onto the outer portion 40, which is also formed from a conductive material. Additionally, the outer portion 40 can be formed as an extension of the conductive member 22.

The outer portion 40 is affixed to the tip 36 of the finger stall 18 by any suitable means such as by stitching or an adhesive, among others, and either partially or totally covers the inner portion 42. The inner portion 42 is disposed against the tip 36 of the stall 18 and projects outwardly therefrom. The inner portion 42 tapers or narrows in some manner from the tip 36 towards the outermost end 44 of the inner portion 42, e.g., can be inwardly angled or curved. The tapering of the inner portion 42 provides a narrow engagement surface that is capable of contacting a conductive device. The outer portion 40 is positioned over the inner portion 42 such that the outer portion 40 conforms to the shape of the inner portion 42, thus providing a single, small contact point of the conductive member 22 on the tip 36.

In this manner the projection 38 provides a contact point on the garment 10 for the conductive member 22 that enables very precise contact of the conductive member 22, via the outer portion 40 of the projection 38, with the conductive device, such that a wearer can precisely control the device without having any stray or multiple contact points between the conductive member 22 and the device interfering with the wearer's control of the device. Additionally, the form and placement of the projection 38 on the tip 36 enables the wearer to see the outermost end 44 of the projection 40 opposite the tip 36, such that the wearer can precisely direct the end 44 of the projection 40 into engagement with the device. In one embodiment, the projection 40 is positioned on the tip 36 closer to the back portion 16 of the glove 10, such that the projection 40 is disposed in a more visible location when the garment 10 is in use.

In another embodiment, the sleeve 18 can be formed only partially of the flexible or stretchable natural or synthetic material. This material is used to form the palm or lower portion 14 of the sleeve 18, while the back or upper portion 16 is formed of a material 60 capable of picking up and/or removing dirt, grease or other material from the surface of the touch sensitive device. In certain embodiments, this material 60 can take the form of a suede, cotton, cotton blend or microfiber-type material. This material 60 is used to form the upper portion 16 of the sleeve 18 such that it can be readily engaged with the device to clean the control surface and facilitate the operation of the device using the sleeve 18. This material 60 can also be utilized to form additional portions of the stall 18 or other garment 10 to provide the associated cleaning function.

In addition, the material 60 can also be formed to be removable from the garment 10 or sleeve 18, such that it can be disposed of and cleaned or replaced when dirtied sufficiently to reduce its cleaning capabilities. Also, the size of the material 60 secured to the garment 10 or sleeve 18 can be selected to be larger than that of the upper portion 16 of the sleeve 18 in order to prevent the material 60 from impeding the stretchable and flexible nature of the material forming the garment 10 or sleeve 18. Additionally, multiple pieces of the material 60 can be utilized on the garment 10 or sleeve 18.

Various other embodiments of the present invention are contemplated as being within the scope of the filed claims particularly pointing out and distinctly claiming the subject matter regarded as the invention.

1. A garment comprising:
a) a shell adapted to receive at least a portion of a finger of a wearer therein, the shell having an interior surface, an exterior surface and an opening for receiving the finger of the wearer;
b) at least one conductive member disposed on the exterior surface of the shell, the at least one conductive member capable of conducting a signal recognizable by a touch-sensitive device.

2. The garment of claim 1 further comprising a cleaning material attached to the shell.

3. The garment of claim 1 wherein the at least one conductive member is formed from a conductive fabric material.

4. The garment of claim 3 wherein the at least one conductive member is affixed to a projection disposed on the exterior surface of the shell.

5. The garment of claim 4 wherein the projection includes an inner portion secured to the exterior surface of the shell and an outer portion secured to the inner portion and optionally the shell.

6. The garment of claim 5 wherein the inner portion has an inwardly tapering shape.

7. The garment of claim 5 wherein the outer portion is integrally formed with the conductive member.

8. The garment of claim 2 further comprising a first conductive portion disposed on the exterior surface and a second conductive portion disposed on the interior surface and connected to the first conductive portion.

9. The garment of claim 8 wherein the conductive member extend through an aperture in the shell to connect the first conductive portion and the second conductive portion to one another.

10. The garment of claim 8 wherein the conductive member extends through opening aperture in the shell to connect the first conductive portion and the second conductive portion to one another.

11. The garment of claim 2 wherein the at least one conductive member is formed of a flowable material capable of adhering to the exterior surface of the shell.

12. The garment of claim 1 further comprising a contact disposed on the exterior surface of the shell and formed of a conductive material, the contact operably connected to the at least one conductive member.

13. The garment of claim 1 wherein the shell is formed as a unitary structure.

14. A method of interacting with an electronic device having a capacitive-type touch-sensing interface, the method comprising the steps of:
a) a shell adapted to receive at least a portion of a finger of a wearer therein, the shell having an interior surface, an exterior surface and an aperture for receiving the finger of the wearer and at least one conductive member disposed on the exterior surface of the shell, the at least one conductive member adapted to conduct a signal recognizable by a touch-sensitive device;
b) inserting the finger of the wearer through the aperture; and
c) placing the at least one conductive member in contact with the touch-sensitive device.

15. The method of claim 16 wherein the garment further comprises a cleaning material attached to the shell, and wherein the method further comprises the step of wiping the device with the cleaning material either prior to or after placing the at least one conductive member in contact with the device.
